(19) United States
(12) Patent Application Publication
(10) Pub. No.: US 2012/0100373 A1
(43) Pub. Date: Apr. 26, 2012

(54) METHOD OF MILLING PARTICLES WITH NANOPARTICLES AND MILLED FREE-FLOWING POWDER

(76) Inventors: Madeline P. Shinbach, St. Paul, MN (US); Jimmie R. Baran, JR., Prescott, WI (US)

(21) Appl. No.: 13/321,008

(22) PCT Filed: Jun. 10, 2010
(86) PCT No.: PCT/US10/38132

§ 371 Date: Nov. 17, 2011

Related U.S. Application Data
(60) Provisional application No. 61/220,698, filed on Jun. 26, 2009.

(51) Int. Cl. B32B 5/16; B02C 19/00; B82Y 99/00

(52) U.S. Cl. 428/402; 241/30; 241/25; 977/773

(57) ABSTRACT

Methods of milling particles in combination with nanoparticles and the resulting free-flowing powder.

### BACKGROUND

WO 2008/079650 and WO 2007/019229 describe adding nanoparticles to particles for the purpose of improving the flow properties.

### SUMMARY

However, it has been found that the addition of nanoparticles to particles as described in WO 2008/079650 and WO 2007/019229 can substantially increase the total energy of powder flow.

Presently described are methods of milling particles in combination with nanoparticles and the resulting free-flowing powder.

In one embodiment, a method of dry milling particles is described comprising providing a mixture comprising i) a plurality of particles and ii) surface-modified inorganic nanoparticles; and milling the mixture such that the milled particles have a reduced particle size.

This embodied method can provide a free-flowing powder comprising dry milled particles and less than 10 wt-% of surface modified nanoparticles.

In another embodiment, a method of milling particles is described comprising providing a mixture comprising i) a plurality of particles, ii) a volatile inert liquid that is not a solvent, and iii) inorganic nanoparticles, and milling the mixture such the liquid evaporates during milling that the particles have a reduced particle size.

In another embodiment, a method of milling particles is described comprising: providing a mixture comprising i) a plurality of particles, ii) a volatile inert liquid that is not a solvent, and iii) non-surface modified inorganic nanoparticles, and milling the mixture such that the milled particles have a reduced particle size.

The later methods can provide a free-flowing powder comprising milled particles and less than 10 wt-% solids of non-surface modified nanoparticles derived from a liquid-containing dispersion.

In another embodiment, a free-flowing powder prepared by milling particles and nanoparticles is described. The milled free-flowing powder has a lower total energy of powder flow than the particles milled without nanoparticles.

In each of the method and free-flowing powder embodiments, the mixture may comprise nanoparticles having an average primary or agglomerate particle size diameter of less than 100 nanometers, 50 nanometers, or 20 nanometers. The mixture typically comprises no greater than 10 wt-%, 5 wt-%, or 1 wt-% of inorganic nanoparticles. The particles may have a median particle size diameter ranging from 100 nanometers to about 200 micrometers.

The nanoparticles typically consist of a material having a Mohs hardness greater than or equal to the particles. The particles may comprise an inorganic material, an organic material, or a combination thereof. In a one preferred embodiment, the particles are excipient particles, such as lactose or lactose monohydrate particles.

### DETAILED DESCRIPTION

Presently described are methods of milling (e.g. larger) particles in combination with nanoparticles. In some embodiments, the nanoparticles enhance the milling efficiency such as characterized by the % yield. In some embodiments, the free-flowing powder of milled particles and nanoparticles exhibits improved properties such as improved particle size uniformity and/or an increased packing density and/or a lower total energy of powder flow.

The particles may be distinguished from the nanoparticles by relative size. The particles are larger than the nanoparticles.

Typically, the nanoparticles have an average primary or agglomerate particle size diameter of less than 100 nanometers. “Agglomerate” refers to a weak association between primary particles which may be held together by charge or polarity and can be broken down into smaller entities. “Primary particle size” refers to the mean diameter of a single (non-aggregate, non-agglomerate) particle. In some embodiments, the nanoparticles have an average particle size of no greater than 75 nanometers or 50 nanometers. The nanoparticles typically have an average primary or agglomerate particle size diameter of at least 3 nanometers. In some preferred embodiments, the average primary or agglomerate particle size is less than 20 nm, 15 nm, or 10 nm. It is preferred that the nanoparticles are unagglomerated. Nanoparticle measurements can be based on transmission electron miscroscopy (TEM).

The particles have a median primary or agglomerate particle size (generally measured as an effective diameter) of at least 100 nm, 200 nm, 300 nm, 400 nm, or 500 nm (i.e. 0.1 microns). The median particle size is typically no greater than about 1,000 micrometers and more typically no greater than 500, 400, 300, or 200 micrometers. In some embodiments, the particles have a polymodal (e.g., bi-modal or tri-modal) distribution.

A variety of inorganic nanoparticles and inorganic or organic particles can be used to practice the present invention.

Exemplary inorganic nanoparticle materials include for example metal phosphates, sulfonates and carbonates (e.g., calcium carbonate, calcium phosphate, hydroxy-apatite); metal oxides (e.g., zirconia, titania, silica, ceria, alumina, iron oxide, vanadia, zinc oxide, antimony oxide, tin oxide, and alumina-silica), and metals (e.g., gold, silver, or other precious metals).

The nanoparticles are typically substantially spherical in shape. However, other shapes such as elongated shapes may alternatively be employed. For elongated shapes, an aspect ratios less than or equal to 10 is typical, with aspect ratios less than or equal to 3 more typical.

The nanoparticles are sufficiently hard and durable such that the nanoparticles aid in the milling of the particles. Without intending to be bound by theory, the (e.g. Mohs) hardness of the nanoparticles is typically greater than or about equal to the (e.g. Mohs) hardness of the particles. For example, in some embodiments, calcium carbonate, reported to have a Mohs hardness of 3 is milled with silica nanoparticles, having a Mohs hardness of 7 or zirconia nanoparticles, having a Mohs hardness of about 8.

Although certain (e.g. crosslinked) organic materials may have sufficient hardness and durability, in some embodiments the nanoparticles preferably comprise an inorganic (e.g. oxide) material such as silica, zirconia, or mixtures thereof.

Various nanoparticles are commercially available. Commercial sources of silica nanoparticles are available from Nalco Co, Napervillle, Ill. Nanoparticles can also be made using techniques known in the art. For example, zirconia nanoparticle can be prepared using hydrothermal technology, as described for example in PCT application US2008/087385.

In some embodiments, the (e.g. non-surface modified) nanoparticles may be in the form of a colloidal dispersion. For example, colloidal silica dispersions are available from Nalco Co. under the trade designations “NALCO 1040,” “NALCO 1050,” “NALCO 1060,” “NALCO 2327,” and “NALCO 2329”. Zirconia nanoparticle dispersions are available from Nalco Chemical Co. under the trade designation “NALCO OOSSOO8” and from Buhler AG Uzwil, Switzerland under the trade designation “Buhler zirconia Z-WO”. Some colloidal dispersions, especially of surface modified nanoparticles, can be dried to provide nanoparticles for dry milling processes.

The nanoparticles may be fully condensed. Fully condensed nanoparticles (with the exception of silica) typically have a degree of crystallinity (measured as isolated metal oxide particles) greater than 55%, preferably greater than 60%, and more preferably greater than 70%. For example, the degree of crystallinity can range up to about 86% or greater. The degree of crystallinity can be determined by X-ray diffraction techniques.

Condensed crystalline (e.g. zirconia) nanoparticles have a high refractive index whereas amorphous nanoparticles typically have a lower refractive index.

In some embodiments, such as when the particles are dry milled with nanoparticles, the nanoparticles are preferably surface modified.

In other embodiments, such as when the particles are milled with nanoparticle dispersions, the nanoparticles can have surface modification but are preferably non-surface modified nanoparticles.

Surface modification involves attaching surface modification agents to inorganic oxide particles to modify the surface characteristics. In general, a surface treatment has a first end that will attach to the nanoparticle surface (covalently, ionically or through strong physisorption) and a second end that imparts steric stabilization that prevents the particles from agglomerating such as permanently fusing together. The inclusion of surface modification can also improve the compatibility of the particles with other materials. For example, an organic end group such as the organic group of an organosilane can improve the compatibility of the particles with organic matrix material such as polymerizable and thermoplastic resins.

Examples of surface treatment agents include alcohols, amines, carboxylic acids, sulfonic acids, phosphonic acids, silanes and titanates. The preferred type of treatment agent is determined, in part, by the chemical nature of the (e.g. metal oxide) nanoparticle surface. Silanes are preferred for silica and for other siliceous fillers. Silanes and carboxylic acids are preferred for metal oxides such as zirconia.

Exemplary silanes include, but are not limited to, alkyltrialkoxysilanes such as n-octyltrimethoxysilane, n-octyltriethoxysilane, isooctyltrimethoxysilane, dodecyltrimethoxysilane, octadecyltrimethoxysilane, propyltrimethoxysilane, and hexyltrimethoxysilane; methacryloxyalkyltrialkoxysilanes or acryloxyalkyltrialkoxysilanes such as 3-methacryloxypropyltrimethoxysilane, 3-acryloxypropyltrimethoxysilane, and 3-(methacryloxy)propyltriethoxysilane; methacryloxyalkylalkyldialkoxysilanes or acryloxyalkylalkyldialkoxysilanes such as 3-(methacryloxy)propylmethyldimethoxysilane, and 3-(acryloxypropyl)methyldimethoxysilane; methacryloxyalkyldialkylalkoxysilanes or acyrloxyalkyldialkylalkoxysilanes such as 3-(methacryloxy)propyldimethylethoxysilane; mercaptoalkyltrialkoxylsilanes such as 3-mercaptopropyltrimethoxysilane; aryltrialkoxysilanes such as styrylethyltrimethoxysilane, phenyltrimethoxysilane, phenyltriethoxysilane, and p-tolyltriethoxysilane; vinyl silanes such as vinylmethyldiacetoxysilane, vinyldimethylethoxysilane, vinylmethyldiethoxysilane, vinyltrimethoxysilane, vinyltriethoxysilane, vinyltriacetoxysilane, vinyltriisopropoxysilane, vinyltrimethoxysilane, vinyltriphenoxysilane, vinyltri-t-butoxysilane, vinyltris(isobutoxy)silane, vinyltriisopropenoxysilane, and vinyltris(2-methoxyethoxy)silane; 3-glycidoxypropyltrialkoxysilane such as glycidoxypropyltrimethoxysilane; polyether silanes such as N-(3-triethoxysilylpropyl)methoxyethoxyethoxyethyl carbamate (PEG3TES), N-(3-triethoxysilylpropyl)methoxyethoxyethoxyethyl carbamate (PEG2TES), and SILQUEST A-1230; and combinations thereof.

In some embodiments, the surface modification agent is a carboxylic acid and/or anion thereof that can impart a polar character to the (e.g. zirconia-containing) nanoparticles.

For example, the surface modification agent may comprise a volatile acid, i.e. monocarboxylic acids having six or less carbon atoms, such as acrylic acid, methacrylic acid, acetic acid, and mixtures thereof. Of these, acetic acid is non-reactive with the organic component; whereas acrylic acid and methacrylic acid are reactive volatile resins since the (meth)acrylate groups of these acids can copolymerize with the (meth)acrylate groups of the monomers of the organic components.

As another example, the surface modification agent can be a carboxylic acid and/or anion thereof having a polyalkylene oxide group. In some embodiments, the carboxylic acid surface modification agent is of the following formula.

H₃C[O—(CH₂)_{y}]ₓ-Q-COOH

In this formula, Q is a divalent organic linking group, x is an integer in the range of 1 to 10, and y is an integer in the range of 1 to 4. The group Q is often an alkylene group, alkenylene group, arylene, oxy, thio, carbonyloxy, carbonylimino, or a combination thereof. Representative examples of this formula include, but are not limited to, 2-[2-(2-methoxyethoxy)ethoxy]acetic acid (MEEAA) and 2-(2-methoxyethoxy)acetic acid (MEAA). Other representative examples are the reaction product of an aliphatic or aromatic anhydride and a polyalkylene oxide mono-ether such as succinic acid mono-[2-(2-methoxy-ethoxy)-ethyl]ester, maleic acid mono-[2-(2-methoxy-ethoxy)-ethyl]ester, and glutaric acid mono-[2-(2-methoxy-ethoxy)-ethyl]ester.

Still other carboxylic acid surface modifying agents are the reaction product of phthalic anhydride with an organic compound having a hydroxyl group. Suitable examples include, for example, phthalic acid mono-(2-phenylsulfanyl-ethyl)ester, phthalic acid mono-(2-phenoxy-ethyl)ester, or phthalic acid mono-[2-(2-methoxy-ethoxy)-ethyl]ester. In some examples, the organic compound having a hydroxyl group is a hydroxyl alkyl (meth)acrylate such as hydroxyethyl (meth)acrylate, hydroxypropyl (meth)acrylate, or hydroxylbutyl (meth)acrylate. Examples include, but are not limited to, succinic acid mono-(2-acryloyloxy-ethyl)ester, maleic acid mono-(2-acryloyloxy-ethyl)ester, glutaric acid mono-(2-acryloyloxy-ethyl)ester, phthalic acid mono-(2-acryloyloxy-ethyl)ester, and phthalic acid mono-(2-acryloyl-butyl)ester. Still others include mono-(meth)acryloxy polyethylene glycol succinate and the analogous materials made from maleic anhydride glutaric anhydride, and phthalic anhydride.

In another example, the surface modification agent is the reaction product of polycaprolactone and succinic anhydride.

Various other surface treatments are known in the art, such as described in WO2007/019229; incorporated herein by reference.

The nanoparticles are typically combined with the surface modification prior to mixing the nanoparticle with the particles. The amount of surface modifier is dependant upon several factors such as nanoparticle size, nanoparticle type, molecular weight of the surface modifier, and modifier type. In general, it is preferred that approximately a monolayer of modifier is attached to the surface of the nanoparticle. The attachment procedure or reaction conditions also depends on the surface modifier used. For silanes it is preferred to surface treat at elevated temperatures under acidic or basic conditions for about 1-24 hour. Surface treatment agents such as carboxylic acids do not require elevated temperatures or extended time.

The surface modification of the nanoparticles in the colloidal dispersion can be accomplished in a variety of ways. The process involves the mixture of an inorganic dispersion with surface modifying agents. Optionally, a co-solvent can be added at this point, such as for example, 1-methoxy-2-propanol, methanol, ethanol, isopropanol, ethylene glycol, N,N-dimethylacetamide, 1-methyl-2-pyrrolidinone, and mixtures thereof. The co-solvent can enhance the solubility of the surface modifying agents as well as the dispersibility of the surface modified nanoparticles. The mixture comprising the inorganic sol and surface modifying agents is subsequently reacted at room or an elevated temperature, with or without mixing.

The (e.g. milled) particles may include organic particles, inorganic particles, and combinations thereof.

Although the particles may also comprise any of the same inorganic materials previously discussed with respect to the nanoparticles, the particles and nanoparticles typically comprise different materials, with the nanoparticles being comprised of a harder material.

Additional exemplary inorganic particles include abrasives, ceramics (including beads, and microspheres), additives such an inorganic pigments, exfolients, cosmetic ingredients, and various fillers such as silicates (e.g., talc, clay, mica, and sericite), calcium carbonate, nepheline (available, for example, under the trade designation “MINEX” from Unimin Corp, New Canaan, Conn.), feldspar and wollastonite.

Exemplary ceramics include aluminates, titanates, zirconates, silicates, doped (e.g., lanthanides, and actinide) versions thereof, and combinations thereof. Ceramic microspheres are marketed, for example, by 3M Company under the trade designation “3M CERAMIC MICROSPHERES” (e.g., grades G-200, G-400, G-600, G-800, G-850, W-210, W-410, and W-610).

The particles may also be inorganic pigment particles. Inorganic pigments include titania, carbon black, Prussian Blue, iron oxide, zinc oxide, zinc ferrite and chromium oxide.

The particles may comprise organic particles including for example polymers, waxes, flame retardants, medicaments, pigments, additives, foodstuffs (e.g. coffee, milled grains), toner materials, pharmaceuticals, and excipients (i.e. an inactive substance used as a carrier for the active ingredient of a medication).

Medicaments include antiallergics, analgesics, bronchodilators, antihistamines, therapeutic proteins and peptides, antitussives, anginal preparations, antibiotics, anti-inflammatory preparations, diuretics, hormones, or sulfonamides, such as, for example, a vasoconstrictive amine, an enzyme, an alkaloid or a steroid, and combinations of any one or more of these. Various medicaments are known in the art such as described in WO 2007/019229; incorporated herein by reference.

Common excipients include dry and solution binders that are added to a (e.g. powder blend), either after a wet granulation step, or as part of a direct powder compression (DC) formula. Examples include gelatin, cellulose and derivatives thereof, starch polyvinylpyrrolidone, sucrose, lactose, lactose monohydrate and other sugars; and polyethylene glycol. Another class of excipients are sugar alcohols and other non-nutritive sweeteners.

Exemplary polymers include poly(vinyl chloride), polyester, poly(ethylene terephthalate), polypropylene, polyethylene, poly vinyl alcohol, epoxies, polyurethanes, polyacrylates, polymethacrylates, and polystyrene.

The particles may also comprise organic pigments. Exemplary classes of organic pigments include phthalocyanine, diarylamide, pyrazolone, isoindolinone, isoinoline, carbazole, anthraquinone, perylene and anthrapyrimidine.

A minor amount of nanoparticles is generally combined with a major amount of particles to form a mixture. The mixture is milled such that the milled particles have a reduced particle size. Without intending to be bound by theory, the primary particle size of the nanoparticles is substantially the same prior to and after milling.

In many embodiments, the nanoparticles will be present in an amount no greater than 10 weight percent solids of the total particle mixture of milled particles and nanoparticles. In some embodiments, the nanoparticles are present in an amount no greater than 5, 4, 3, 2, or 1 weight percent solids. The amount of nanoparticles is typically at least 0.01 wt-%, 0.05 wt-%, or 0.10 wt-% solids. However, if the milled particles are a concentrated master batch, the concentration of nanoparticles may be substantially higher.

The mixture of particles and nanoparticles is milled with a milling apparatus. Various milling apparatus are known in the art including for example ball mills, rotary mills, and fluid air milling systems.

A ball mill is a cylindrical device used in grinding or mixing materials. Ball mills typically rotate around a horizontal axis, partially filled with the material to be ground (i.e. the particles and nanoparticles) in addition to a grinding medium. Different materials are used as media, including ceramic balls such as high density alumina media, flint pebbles and stainless steel balls. An internal cascading effect reduces the particulate material to a finer powder. Industrial ball mills can operate continuously, fed at one end and discharged at the other end. Large to medium-sized ball mills are mechanically rotated on their axis, but small ones normally consist of a cylindrical capped container that sits on two drive shafts with belts used to transmit rotary motion.

Rotary mills, are also referred to as burr mills, disk mills, and attrition mills, typically include two metal plates having small projections (i.e. burrs). Alternatively, abrasive stones may be employed as the grinding plates. One plate may be stationary while the other rotates, or both may rotate in opposite directions.

A fluid air milling system utilizes turbulent free jets in combination with a high efficiency centrifugal classifier in a common housing. A typical fluid air milling system includes an inlet, chamber with rotor, screen, and an outlet. Feed is introduced into the common housing through either a double flapper valve or injector. Flooding the pulverizing zone to a level above the grinding nozzles forms the mill load. Turbulent free jets are used to accelerate the particles for impact and breakage. After impact the fluid and size reduced particles leave the bed and travel upwards to the centrifugal classifier where rotor speed will define which size will continue with the fluid through the rotor and which will be rejected back to the particle bed for further size reduction. The high degree of particle dispersion leaving the pulverizing zone aids in the efficient removal of fine particles by the classifier. Operating parameters of rotor speed, nozzle pressure, and bed level allow for optimizing productivity, product size, and distribution shape (slope). A low-pressure air purge is used to seal the gap between the rotor and the outlet plenum eliminating particles bypassing the rotor and allowing for close top size control.

Suitable commercially available milling equipment includes for example high pressure homogenizers available from Avestin, Inc. Ottawa, Ontario under the trade designation “EmulsiFlex” and “Microfluidizer” processsors available from Microfluidics.

The operating conditions of the mill are generally chosen to obtain the smallest mean particle size in a time frame optimized for yield. This it typically the maximum rotor speed (e.g. 10,000 rpm) of the milling device.

In some embodiments, the method comprises providing a mixture comprising a plurality of particles, and (i.e. dry) surface-modified nanoparticles; and dry milling the mixture.

Such method provides a free-flowing powder comprising dry milled particles and surface modified nanoparticles.

In other embodiments, the method comprises providing a mixture comprising a plurality of particles, a volatile inert liquid that is not a solvent, and a nanoparticle-containing colloidal dispersion. Typical liquids that may be employed include, for example, toluene, isopropanol, heptane, hexane, octane, and water. Such method provides a free-flowing powder comprising wet milled particles and non-surface modified nanoparticles.

Such method provides free-flowing powder comprising milled particles and less than 10 wt-% of non-surface modified nanoparticles derived from a liquid dispersion.

Unlike convention wet milling methods that employ appreciable amounts of liquid such that a slurry is formed, in some embodiments, the amount of liquid is sufficiently small such that the liquid evaporates during milling. The concentration of liquid in the mixture to be milled is less than 5 wt-%. In some embodiments, the amount of liquid is no greater 4, 3, 2, 1, or 0.5 wt-%.

It is preferred to utilize non-surface-modified nanoparticles, rather than surface modified nanoparticle to increase packing density. If higher concentration of liquids are employed as in the case of conventional wet milling method, the method then typically further comprises removing the liquid, for example by filtering and/or evaporation to recover a free-flowing dry powder.

Generally, the unmilled larger particles preferably a have median particle size greater than 100, 200, 300, 400, or 500 nanometers (0.1 microns) and less than 200 microns, as previously described. The milled particles can have a median particle size of about ⅙ to about ⅔ of the median particle size of the particles of the unmilled mixture. With optimization of the milling procedure and nanoparticle the median particle size may be even smaller.

The inclusion of the nanoparticles can provide various beneficial properties to the resulting free-flowing powder.

In some embodiments, the milled particles have improved uniformity, as evidenced by a lower standard deviation of median particle size (i.e. relative to the same particles milled in the absence of nanoparticles). For example, in some embodiments, the standard deviation of the median particle size was reduced from about 9-10 microns to 4-5 microns. The standard deviation of the median particle size may be reduced by 10%, 20%, 30%, 40%, 50%, or even greater with optimization (i.e. relative to the same particles milled in the absence of nanoparticles).

In one favored embodiment, the inclusion of the nanoparticles with the particles during milling increases the % yield, i.e. the amount of milled particles of a specified size range. The specified size range may include the milled particles of a (e.g. target) median particle size and the particles that vary from the median particle size within a standard deviation. The inclusion of the nanoparticles during milling has been found to improve the yield by 10%, 20%, 30%, 40%, and 50%. In favored embodiments, the improvement in yield, is 60%, 70%, 80%, 90%, 100% (i.e. twice the amount of milled particle within the specified size range) or even greater.

In one favored embodiment, the milled particles have a higher packing density (i.e. relative to the same particles milled in the absence of nanoparticles). For example, the packing density can increase by 0.2, 0.4, 0.6, 0.8, 1.0 or 1.2 g/cc. An increase in packing density of even 5 or 10% can be particularly beneficial for reducing the volume of powdered materials for shipping. In some embodiments, the packing density was increased by at least 20% relative to the same particles milled in the absence of nanoparticles and by as much as 50% to 250% relative to post addition of (e.g. surface modified) nanoparticles.

In another favored embodiment, the milled particles exhibit a lower total energy of powder flow (i.e. relative to the same particles milled in the absence of nanoparticles). This equates to less energy expenditure for handing (e.g. conveying and mixing) powdered materials. It has been found that the inclusion of nanoparticles can lower the total energy of powder flow by 5%, 10%, 20%, 30%, 40%, 50%, 60%, or greater.

The free-flowing powder can exhibit any one or combination of improved properties as just described. In a favored embodiment, the free-flowing powder exhibits a combination of increased packing density and a lower total energy of powder flow. Various modifications and alterations of this invention will be apparent to those skilled in the art without departing from the scope and spirit of this invention, and it should be understood that this invention is not limited to the illustrative embodiments set forth herein.

### EXAMPLES

These examples are for illustrative purposes only and are not meant to be limiting on the scope of the appended claims. All parts, percentages, and ratios in the examples and the rest of the specification are based on weight, unless noted otherwise. Solvents and other reagents used were obtained from Sigma-Aldrich Chemical Company (Milwaukee, Wis.) unless otherwise noted.

### Particles Employed in the Examples

Titania, a millable material was obtained as Hombikat UV100 from Sachteleben Chemie, GmbH, Duisberg, Germany.

Calcium carbonate, a millable material was obtained from Sigma-Aldrich Chemical Company (Milwaukee, Wis.)

Lactose monohydrate, a millable material was obtained from Alfa Aesar Company (Ward Hill, Ma)

### Nanoparticles Employed in the Examples

Non-surface modified 5 nm silica nanoparticles—(NM 5 nm SiO₂) (16.6% solids in water from Nalco Company, Naperville, Ill. under the trade designation NALCO 2326)

Non-surface modified 20 nm silica nanoparticles—(NM 20 nm SiO₂) (41.45% solids in water from Nalco Company, Naperville, Ill. under the trade designation NALCO 2327)

### Preparation of Surface Modified 5 nm Silica Nanoparticles (SM 5 Nm SiO₂)

100 g of NALCO 2326 (16.6% solids in water from Nalco Company, Naperville, Ill.) was measured into a 3-neck round-bottom flask (Ace Glass, Vineland, N.J.). A glass stirring rod with a Teflon paddle was attached to the center neck of the round-bottom flask. The flask was lowered into the oil bath, a condenser was attached, and then the contents were allowed to stir at a medium-high rate. 112.5 g of an 80:20 mixture of ethanol (EMD, Gibbstown, N.J.) and methanol (VWR, West Chester, Pa.) was prepared in a 250 mL glass beaker. In a 150 mL beaker, the following components were measured in the following order: half of the 80:20 ethanol:methanol mixture, 7.54 g of isooctyltrimethoxy silane (IOTMS, Gelest, Morrisville, Pa.) and 0.81 g of methyltrimethoxy silane (Sigma-Aldrich Corp., St. Louis, Mo.) The solution was mixed thoroughly and then added to the 3-neck round-bottom flask containing the Nalco 2326 material. The remaining half of the 80:20 ethanol:methanol was used to rinse any leftover silane from the 150 mL beaker into the reaction. The reaction was allowed to stir for 4 hours in an oil bath set at 80° C. The surface modified nanoparticles were transferred to a crystallizing dish and dried in an oven set at 150° C. for approximately 1.5 hours.

### Preparation of Surface Modified 20 nm Nanoparticles (SM 20 nm SiO₂)

The procedure followed was the same as described for Preparatory Example 1, except for 100 g NALCO 2327 (41.45%), and 4.02 g IOTMS and 112.5 g MP were used.

### Preparatory Example 3

### SM ZrO₂

A ZrO₂ sols was prepared as described in WO2009/085926. The resulting zirconia sol having an average primary particle size of 8-10 nm was stabilized with 1.4 millimoles acetic acid per gram of zirconia oxide.

### Examples 1-4 and 9-14

Millable particles in the amount specified in Table 1, was blended with dry nanoparticles in the amount (in percent based on millable particles) as indicated in the tables in a one quart glass jar. The jar containing the mixture was shaken by hand to ensure thorough mixing of the two solids. The mixture was then transferred into a fluid bed impact mill (Hosokawa Alpine 100 AFG Fluidised Bed from Hosokawa Micron Powder Systems, Summit, N.J.) and dry milled for 30 minutes at 10,000 RPM using an air pressure of 80 psi. The material removed at the end of the milling period was weighed and analyzed for particle size. The results are reported in the following tables.

### Examples 5-8

Millable particles in the amount specified in the tables, were placed in a fluid bed impact mill followed by the nanoparticles in water, which were metered into the mill in the amount indicated in tables during a one minute period and milled for 30 minutes. Since the particles were milled using a liquid (i.e. water) content of less than 0.5 wt-%, the water evaporated during the milling process. The material removed at the end of the milling period was weighed and analyzed for particle size. The results are reported in the tables.

### Control 2

99.5 g CaCO₃ and 0.5 g of nanoparticles SM 5 nm SiO₂ were mixed at 3000 RPM in a FlackTek Speedmixer (FlackTek, Inc., Landrum, S.C., Model DAC150 FVZ).

### Powder Rheology and Packing Density Measurements

Powder rheology and packing density data were acquired using a Freeman FT4 powder rheometer (Freeman Technologies, Ltd., Worcestershire, UK). The reproducibility module that comes standard with the FT4 was used. The Total Energy of Powder Flow reported is the value from the seventh test in the procedure at which point the test powder has reaches equilibrium.

TABLE 1
Milling of Particles

| | | | | Median | Std Dev |
|---|---|---|---|---|---|
| | | | | Particle Size | (before) |
| | Millable | | | (before) and | and after |
| Example | particles | Nanoparticles | | after milling | milling |
| # | (g) | (wt-% solids) | *Yield % | microns | microns |
| 1 | CaCO₃ | None | 40.81% | (47.178) | (21.82) |
| Control | (100.28) | | | 9.784 | 8.589 |
| 2 | CaCO₃ | 0.5% SM 5 nm | 74.27% | (46.435) | (21.88) |
| | (90.04) | SiO₂ | | 12.881 | 39.44 |
| 3 | CaCO₃ | 0.1% SM 5 nm | 52.30% | (46.859) | (21.31) |
| | (149.47) | SiO₂ | | 10.32 | 5.585 |
| 4 | CaCO₃ | 0.5% SM 20 nm | 49.83% | (49.320) | (20.030) |
| | (109.66) | SiO₂-2 | | 11.090 | 4.550 |
| 5-Wet | CaCO₃ | 0.1% NM 5 nm | 57.12% | (47.133) | (22.41) |
| | (101.56) | SiO₂ | | 9.939 | 5.37 |
| 6-Wet | CaCO₃ | 0.5% NM 5 nm | 51.54% | (45.745) | (25.44) |
| | (99.7) | SiO₂ | | 9.841 | 4.595 |
| 7-Wet | CaCO₃ | 0.1% NM 20 nm | 61.71% | (46.800) | (20.200) |
| | (109.41) | SiO₂ | | 11.220 | 4.450 |
| 8-Wet | CaCO₃ | 0.1% SM ZrO₂ | 76.80% | (42.990) | (17.600) |
| | | | | 11.010 | 4.160 |
| 9 | Titania | None | 89.71% | (15.399) | (54.12) |
| Control | (104.53) | | | 14.020 | 26.61 |
| 10 | Titania | 0.1% SM 5 nm | 92.33% | (12.944) | (16.650) |
| | (103.07) | SiO₂ | | 6.211 | 16.270 |
| 11 | Titania | 0.5% SM 5 nm | 90.05% | (15.088) | (34.75) |
| | (99.95) | SiO₂ | | 9.699 | 24.94 |
| 12 | Lactose | None | 25.65% | (43.43) | (52.91) |
| Control | (93.28) | | | 10.44 | 9.050 |
| 13 | Lactose | 0.1% SM 5 nm | 48.74% | (32.55) | (36.13) |
| | (91.18) | SiO₂ | | 5.09 | 4.377 |
| 14 | Lactose | 0.5% SM 5 nm | 49.74% | (34.85) | (69.46) |
| | | SiO₂ | | 7.660 | 7.774 |

*% Yield is the percentage of the total amount of material milled having the median size within the standard deviation

Table 1 illustrates that milling particles in the presence of nanoparticles can improve the yield. Table 1 also illustrates that milling particles in the presence of nanoparticles can improve the uniformity of the resulting powder, as evidenced by the lower standard deviation. Examples

TABLE 2
Dry and Wet Milling of CaCO₃

| | | Change in | | Change in |
|---|---|---|---|---|
| | Total Energy | Total Energy | Packing | Packing |
| | (mJ) of Powder | (Milled Total | Density | Density |
| | Flow (before) | Energy of | (g/cc) | (Milled |
| | and after | Column 1- | (before) and | Density- |
| Example # | milling | 72.2) | after milling | 0.345) |
| Control 1- | (78.3) | | (0.345) | +0.644 |
| Dry Milled | 72.2 | | 0.989 | |
| Control | | | | |
| Control 2- | (78.3) | +262.8 | (0.345) | +0.293 |
| post added | 335 | | 0.638 | |
| nanoparticles | | | | |
| 2 | 106 | +33.8 | 1.074 | +0.729 |
| 3 | 64.0 | −8.2 | 0.995 | +0.650 |
| 4 | 92.5 | +20.0 | 1.117 | +0.772 |
| 5-Wet | 100.0 | +27.8 | 1.023 | +0.678 |
| 0.1% NM 5 | | | | |
| nm SiO₂ | | | | |
| 6-Wet | 133.0 | +60.8 | 1.021 | +0.676 |
| 0.5% NM 5 | | | | |
| nm SiO₂ | | | | |
| 7-Wet | 119.0 | +46.8 | 0.915 | +0.570 |
| 0.1% NM | | | | |
| 20 nm SiO₂ | | | | |
| 8-Wet | 128.0 | +9.0 | 0.933 | +0.588 |
| SM ZrO₂ | | | | |

Control 2 illustrates that post adding surface modified nanoparticles results in a substantial increase in total energy of powder flow and lower increase in packing density. Example 3 demonstrates that milling (e.g. CaCO₃) particles in the presence of nanoparticles can reduce the total energy of powder flow of the resulting free-flowing powder in comparison to particles milled without nanoparticles. Examples 2-6 demonstrate that milling (e.g. CaCO₃) particles in the presence of nanoparticles can increase the packing density in comparison to milling the particles in the absence of nanoparticles. Examples 5-8 demonstrate that the unmodified 5 nm SiO₂ nanoparticles provide an improvement (i.e. increase) in packing density in comparison to milling the particles in the absence of nanoparticles; whereas the unmodified 20 nm SiO₂ nanoparticles and surface modified ZrO₂ nanoparticles did not provide such increase in packing density.

TABLE 3
Dry Milling of Titania and Lactose

| | Total Energy | | Packing | |
|---|---|---|---|---|
| | (mJ) of Powder | | Density | |
| | Flow (before) | Change | (g/cc) | Change in |
| | and after | in Total | (before) and | Packing |
| Example # | milling | Energy | after milling | Density |
| 9 | (96.8) | | (0.377) | −0.111 |
| Control | 80.2 | | 0.266 | |
| 10 | 58.3 | −21.9 | 0.241 | −0.136 |
| 11 | 55.2 | −25.0 | 0.248 | −0.129 |
| 12 | (127.0) | | (0.541) | −0.151 |
| Control | 83.6 | | 0.390 | |
| 13 | 60.3 | −23.3 | 0.449 | −0.092 |
| 14 | 32.0 | −51.6 | 0.572 | +0.031 |

Table 3 demonstrates that dry milling particles in the presence of surface modified nanoparticles can reduce the total energy of powder flow of the resulting free-flowing powder in comparison to particles milled in the absence of nanoparticles. Examples 12-14 demonstrate that milling (e.g. lactose monohydrate) particles in the presence of nanoparticles can increase the packing density in comparison to particles milled in the absence of nanoparticles.

1. A method of dry milling particles comprising:
providing a mixture comprising:
i) a plurality of particles, and
ii) surface-modified inorganic nanoparticles;
milling the mixture such that the milled particles have a reduced particle size.

2. A method of milling particles comprising:
providing a mixture comprising:
i) a plurality of particles,
ii) a volatile inert liquid that is not a solvent, and
iii) inorganic nanoparticles, and
milling the mixture such that the liquid evaporates during milling and the milled particles have a reduced particle size.

3. The method of claim 2 wherein the nanoparticles are non-surface modified nanoparticles.

4. (canceled)

5. The method of claim 2 further comprising removing the liquid to form a dry powder.

6. The method of claim 1 wherein the mixture comprises nanoparticles having an average primary or agglomerate particle size diameter of less than 100 nanometers.

7. The method of claim 1 wherein the nanoparticles have an average primary or agglomerate size diameter of less than 20 nm.

8. The method of claim 1 wherein the mixture comprises no greater than 10 wt-% of the nanoparticles.

9. The method of claim 1 wherein the mixture comprises no greater than 5 wt-% of the nanoparticles.

10. The method of claim 1 wherein the mixture comprises no greater than 1 wt-% of the nanoparticles.

11. The method of claim 1 wherein the mixture comprises particles having a median particle size diameter ranging from 100 nanometers to about 200 micrometers.

12. The method of claim 1 wherein the nanoparticles have a Mohs hardness greater than or equal to the particles.

13. (canceled)

14. The method of claim 1 wherein the particles comprise an inorganic material, an organic material, or a combination thereof.

15. The method of claim 1 wherein the particles comprise an excipient.

16. (canceled)

17. The method of claim 1 wherein the nanoparticles provide up to a 100% improvement in yield of milled particles of a specified size range.

18. The method of claim 1 wherein the milled particles have a median particle size of about ⅙ to about ⅔ of the median particle size of the particles of the unmilled mixture.

19. The method of claim 1 wherein the milled particles have a lower standard deviation of median particle size relative to the particles milled in the absence of nanoparticles.

20. The method of claim 1 wherein the milled particles have a higher packing density relative to the particles milled in the absence of nanoparticles.

21. The method of claim 1 wherein the milled particles have a lower total energy of powder flow relative to the particles milled in the absence of nanoparticles.

22. The method of claim 1 wherein the milling is provided by means of a ball mill, rotary mill, fluid air milling system, or combination thereof.

23. (canceled)

24. A free-flowing powder comprising milled particles and less than 10 wt-% of non-surface modified nanoparticles derived from a liquid dispersion.

25-35. (canceled)
